(19) United States
(12) Patent Application Publication
(10) Pub. No.: US 2026/0321056 A1
(43) Pub. Date: Oct. 15, 2026

(54) A FINGERPRINT RECOGNITION ACCESS CONTROL METHOD AND SYSTEM

(71) Applicant: HANGZHOU SYNOCHIP DATA SECURITY TECHNOLOGY CO., LTD, Hangzhou, Zhejiang (CN)

(72) Inventors: Feifei ZHANG, Hangzhou (CN); Hongchang LUO, Hangzhou (CN); Peng QIAN, Hangzhou (CN)

(73) Assignee: HANGZHOU SYNOCHIP DATA SECURITY TECHNOLOGY CO., LTD, Hangzhou, Zhejiang (CN)

(21) Appl. No.: 18/994,361

(22) PCT Filed: Nov. 20, 2023
(86) PCT No.: PCT/CN2023/132694

§ 371 Date: Jan. 14, 2025

(30) Foreign Application Priority Data
Nov. 15, 2023 (CN) 202311518703.9

(51) Int. Cl. G06V 40/12; G06F 21/32; G06V 10/26; G06V 10/44; G06V 10/74; G06V 40/13

(52) U.S. Cl. CPC G06V 40/1365; G06F 21/32; G06V 10/26; G06V 10/44; G06V 10/761; G06V 40/13; G06V 40/1347

(57) ABSTRACT

A fingerprint recognition access control method and system, the method including: real-time collection of fingerprint images for fingerprint recognition of the same user; According to the gray value of the pixel block in the fingerprint part of the collected fingerprint image, the first gray threshold and the second gray threshold corresponding to the current fingerprint image are obtained. The first gray threshold and the second gray threshold are used to obtain a plurality of image blocks to be recognized, and combined with the gray value of the image blocks to obtain the comprehensive similarity value of the current fingerprint image. When the comprehensive similarity value is not lower than the preset similarity threshold, the fingerprint image of the current user is judged to pass fingerprint verification. The system includes modules corresponding to the method steps.

### TECHNICAL FIELD

The invention relates to the field of fingerprint recognition technology, particularly to a fingerprint recognition access control method and system.

### BACKGROUND TECHNOLOGY

Fingerprint recognition technology is a kind of biometric authentication technology, which has the characteristics of uniqueness and stability, and has a wide range of applications in the field of security protection. At present, most of the fingerprint recognition products on the market use capacitive or optical sensors to capture fingerprint images, and then use specific algorithms to extract features for comparison, in order to determine whether they are legitimate users. These products usually require users to provide specific press posture and strength, and are greatly affected by the degree of finger moistness, resulting in an unsatisfactory user experience.

In addition, in the era of mobile Internet, people have higher and higher requirements for identity authentication, hoping to complete identity authentication quickly and accurately. At the same time, they also hope that the identity authentication process is as simple and convenient as possible, without too much burden to users. This requires the fingerprint recognition system to provide a good user experience while ensuring the accuracy of recognition.

### INVENTION CONTENT

The invention provides a fingerprint recognition access control method and system to solve the problem that traditional fingerprint recognition needs to recognize all features of the whole fingerprint image, and the processing efficiency and recognition response speed are low due to the large fingerprint area corresponding to fingerprint recognition. However, extracting local fingerprint image blocks for recognition can reduce the recognition area, but the recognition accuracy is low. The invention extracts fingerprint image blocks. However, according to the traditional image block extraction method, it is impossible to screen out the image blocks with the strongest fingerprint feature representation. Therefore, due to the weak representativeness of the selected fingerprint image blocks, it is easy to encounter problems such as a high probability of fingerprint recognition failure and low accuracy of fingerprint recognition.

The invention provides a fingerprint recognition access control method, the fingerprint recognition access control method includes:
S1: Real-time collection of fingerprint images for the same user for fingerprint recognition;
S2: According to the gray value of the pixel block in the fingerprint part of the collected fingerprint image, the first gray threshold and the second gray threshold corresponding to the current fingerprint image are obtained. Wherein, the first gray threshold is greater than the second gray threshold;
S3: Using the first gray threshold and the second gray threshold to obtain a plurality of image blocks to be recognized, and combined with the gray value of the image blocks to obtain the comprehensive similarity value of the current fingerprint image.
S4: When the comprehensive similarity value is not lower than the preset similarity threshold, the fingerprint image of the current user is judged to pass fingerprint verification.

Further, according to the gray value of the pixel block of the fingerprint part of the currently collected fingerprint image, the first gray threshold and the second gray threshold corresponding to the current fingerprint image are obtained, including:
S21: Extract the gray value of the pixel block of the fingerprint part of the current fingerprint image;
S22: The gray value of the pixel block in the fingerprint part, which is lower than the optimal threshold corresponding to the fingerprint image is extracted as the first gray value data;
S23: The gray value of the pixel block in the fingerprint part, which is not lower than the optimal threshold corresponding to the fingerprint image is extracted as the second gray value data;
S24: Using the first gray value data to set the first candidate scale threshold for the fingerprint part;
S25: Using the second gray value data to set the second candidate gray threshold for the fingerprint part;
S26: The first candidate gray threshold is compared with the second candidate gray threshold, and select the larger of the first and second candidate gray thresholds as the first grayscale threshold, and select the smaller of the first and second candidate gray thresholds as the second gray threshold.

Further, the first gray threshold and the second gray threshold to obtain a plurality of image blocks to be recognized, and combining the gray value of the image block to be recognized to obtain the comprehensive similarity value of the current fingerprint image, including:
S31: The fingerprint image is segmented by the first gray threshold and the second gray threshold, and multiple first image blocks and second image blocks to be recognized are obtained;
S32: Compare the multiple first and second image blocks to be recognized with the corresponding fingerprint positions of the fingerprint reference images that the user has entered into the database, and obtain the similarity values for each of the multiple first and second image blocks to be recognized;
S33: Using the similarity values corresponding to each of the multiple first and second image blocks to be recognized, combined with the gray value of the image to be recognized, to obtain the comprehensive similarity value of the current fingerprint image.

Further, the fingerprint image is segmented through the first gray threshold and the second gray threshold to obtain a plurality of image blocks to be recognized, including:
S311: Extract gray values of all pixel blocks in the fingerprint part of the fingerprint image;
S312: Extract pixel blocks with gray values exceeding the first gray threshold as the first type of pixel block;
S313: In the first type of pixel block, the target area containing the number of block of the first type of pixel block exceeding the preset threshold value of the first block number in the first target area is called as the first target area;
S314: According to the position of the first target area, the fingerprint image is segmented to obtain the first image block to be recognized;
S315: The pixel block whose gray value exceeds the second gray threshold, but does not exceed the first gray threshold, is extracted as the second type of pixel block;
S316: In the second type of pixel block, the target area containing the number of block of the second type of pixel block exceeding the preset threshold value of the second block number in the target area is called as the second target area;
S317: According to the position of the second target area, the fingerprint image is segmented to obtain the second image block to be recognized.

Further, the first target area is smaller than the second target area, and the ratio between the first target area and the second target area is 1:1.7-1:2.3; At the same time, the first block count threshold is smaller than the second block count threshold, and the ratio between the first block count threshold and the second block count threshold is 1:2.1-1:2.8.

The invention provides a fingerprint recognition access control system, the fingerprint recognition access control system includes:
Image acquisition module: real-time acquisition of fingerprint images for the same user for fingerprint recognition;
Threshold acquisition module: According to the gray value of the pixel block of the fingerprint part of the currently collected fingerprint image, the first gray threshold and the second gray threshold corresponding to the current fingerprint image are obtained. Wherein, the first gray threshold is greater than the second gray threshold;
Image block acquisition module: using the first gray threshold value and the second gray threshold value to obtain a plurality of image blocks to be recognized, and combined with the gray value of the image blocks to be recognized to obtain the comprehensive similarity value of the current fingerprint image;
Similarity judgment module: When the comprehensive similarity value is not lower than the preset similarity threshold, the fingerprint image of the current user is judged to pass fingerprint verification.

Further, the threshold acquisition module, including:
Gray value extraction module: extract the gray value of the pixel block of the fingerprint part of the current fingerprint image;
The first gray value data module: extracts the gray value of the pixel block in the fingerprint part that is lower than the optimal threshold corresponding to the fingerprint image, and takes it as the first gray value data;
The second gray value data module: extracts the gray value of the pixel block in the fingerprint part which is not lower than the optimal threshold corresponding to the fingerprint image, and takes it as the second gray value data;
The first candidate gray threshold module: using the first gray value data to set the first candidate gray threshold of the fingerprint part;
The second candidate gray threshold module: using the second gray value data to set the second candidate gray threshold of the fingerprint part;
Threshold comparison module: the first candidate gray threshold is compared with the second candidate gray threshold, and the larger candidate gray threshold between the first candidate gray threshold and the second candidate gray threshold is taken as the first gray threshold, and the smaller candidate gray threshold between the first candidate gray threshold and the second candidate gray threshold is taken as the second gray threshold.

Further, the image block acquisition module, including:
To be recognized image block acquisition module: the fingerprint image is segmented by the first gray threshold and the second gray threshold, and multiple first and second image blocks to be recognized are obtained;
Similarity value comparison module: the first and second image blocks to be recognized are compared with the fingerprint position corresponding to the fingerprint reference image that the user has entered into the database, and the corresponding similarity value of the first and second image blocks to be recognized is obtained.

Similarity value acquisition module: using the similarity values corresponding to each of the multiple first and second image blocks to be recognized, combined with the scale value of the image to be recognized, to obtain the comprehensive similarity value of the current fingerprint image.

Further, the acquisition module of the image block to be recognized, including:
Gray value extraction module: extracting gray value of all pixel blocks in the fingerprint part of the fingerprint image;
The first type of pixel block module: extracts the pixel block whose gray value exceeds the first gray threshold as the first type of pixel block;
Target area setting module: in the first type of pixel block, the target area containing the number of blocks of the first type of pixel block in the area of the first type of pixel block exceeds the preset threshold value of the first block number, as the first target area;
The first image block module to be recognized: according to the position of the first target area, the fingerprint image is segmented to obtain the first image block to be recognized;
The second type of pixel block determination module: extracts the pixel block whose gray value exceeds the second gray threshold, but does not exceed the first gray threshold, as the second type of pixel block;
The area region retrieval module: in the second type of pixel block, retrieve the target area containing the second type of pixel block whose number of blocks exceeds the preset threshold value of the second block number as the second target area;
The second target area module: according to the position of the second target area, the fingerprint image is segmented to obtain the second image block to be recognized.

Further, the first target area is smaller than the second target area, and the ratio between the first target area and the second target area is 1:1.7-1:2.3; At the same time, the first block count threshold is smaller than the second block count threshold, and the ratio between the first block count threshold and the second count block threshold is 1:2.1-1:2.8.

Beneficial effects of the invention: the technical scheme of the invention reduces the possibility of misidentification and missing identification by real-time acquisition and comparison of multiple fingerprint images provided by the user, improves the accuracy and security of fingerprint identification, and avoids the complicated manual feature extraction and matching process by adopting the gray value comparison method, thus greatly saving time and computing resources; The invention has the characteristics of fast and convenient, can provide good user experience, and is suitable for application in various access control systems. By extracting local fingerprint image blocks for recognition, the recognition area can be reduced, the processing time and responsing time can be reduced, and the recognition efficiency can be improved. The accuracy of fingerprint recognition can be enhanced and the probability of recognition failure can be reduced by extracting fingerprint image blocks and selecting the most powerful image blocks. By improving the image block extraction method and selecting the image block with the strongest fingerprint characteristics, the robustness of fingerprint recognition can be enhanced, which makes the fingerprint recognition system have better performance in the face of different fingerprint images. By improving the efficiency and accuracy of fingerprint recognition, the demand for hardware resources can be reduced, thus reducing the cost of fingerprint recognition system. By improving the identification efficiency and accuracy, the user waiting time can be reduced and the response speed of the system can be improved, thus improving the user experience.

### BRIEF DESCRIPTION OF THE DRAWINGS

FIG. 1 is a step diagram of a fingerprint recognition access control method of the invention;

FIG. 2 is a module diagram of a fingerprint recognition access control system of the invention.

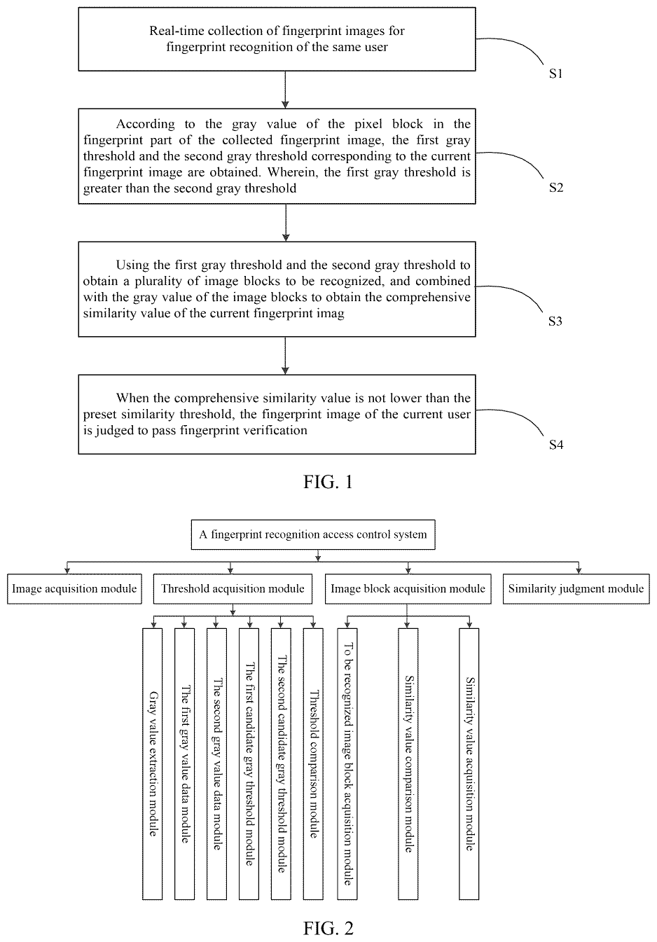

### SPECIFIC IMPLEMENTATION METHOD

The preferred embodiments of the invention are described below in conjunction with the accompanying drawings. It should be understood that the preferred embodiments described herein are only for illustrating and explaining the invention, and are not intended to limit the invention.

### Example 1

The embodiment relates to a fingerprint recognition access control method. The fingerprint recognition access control method comprises:
S1: Real-time collection of fingerprint images for the same user for fingerprint recognition;
S2: According to the gray value of the pixel block in the fingerprint part of the collected fingerprint image, the first gray threshold and the second gray threshold corresponding to the current fingerprint image are obtained. Wherein, the first gray threshold is greater than the second gray threshold;
S3: Using the first gray threshold and the second gray threshold to obtain a plurality of image blocks to be recognized, and combined with the gray value of the image blocks to obtain the comprehensive similarity value of the current fingerprint image.
S4: When the comprehensive similarity value is not lower than the preset similarity threshold, the fingerprint image of the current user is judged to pass fingerprint verification.

The working principle of the above technical scheme is as follows: the user presses the fingerprint sensor on the access control system, and the system collects the fingerprint image of the user for fingerprint recognition in real time. By analyzing the gray value of the pixel block in the fingerprint part of the currently collected fingerprint image, the system obtains the first gray threshold and the second gray threshold corresponding to the current fingerprint image. These thresholds may be used to identify specific features in fingerprint images for subsequent comparison and verification. Using the first gray threshold value and the second gray threshold value, the system divides the fingerprint image into multiple image blocks to be recognized, and combines the gray value of these image blocks to calculate the comprehensive similarity value of the current fingerprint image. This step may involve extracting the features of the fingerprint image and then comparing them with the reference features stored in the database to calculate the similarity. When the comprehensive similarity value reaches or exceeds the preset similarity threshold, the system determines that the fingerprint image of the current user passes fingerprint verification, thus allowing the user to obtain the access control permission.

The effects of the above technical scheme are as follows: the technical scheme can improve the user experience, provide a novel gray value comparison method, avoid the complex manual feature extraction and matching process, greatly save time and computing resources, save a lot of manpower and material resources, improve operation and maintenance efficiency and management level. By analyzing the gray value of fingerprint image and calculating the comprehensive similarity, the fingerprint image can be recognized with high precision. This helps ensure that only authorized users can pass through the access control system, increasing security. Through the use of gray threshold, it is possible to effectively deal with some simple fingerprint forgery attacks, such as using false fingerprints. This increases the security of the access control system and avoids being deceived by illegally copied fingerprints. The process of collecting and processing fingerprint images is real-time, so the user can quickly obtain the corresponding verification results after pressing the fingerprint on the access control system, improving the user experience. The method dynamically obtains the gray threshold based on the features of the currently collected fingerprint images, and calculates the similarity based on the gray values of the image blocks to be recognized. Therefore, the method can adapt to the changes of fingerprint features in different environments, and improves the robustness and applicability of the system. Judging by the preset similarity threshold can avoid misjudgment and missing judgment to a certain extent, and improve the reliability of fingerprint verification.

### Example 2

In this embodiment, according to the gray value of the pixel block of the fingerprint part of the currently collected fingerprint image, the first gray threshold and the second gray threshold corresponding to the current fingerprint image are obtained, including:
S21: Extract the gray value of the pixel block of the fingerprint part of the current fingerprint image;
S22: Extract the gray value of the pixel block in the fingerprint part that is lower than the optimal threshold corresponding to the fingerprint image (the optimal threshold value can be obtained by otsu algorithm), as the first gray value data;
S23: The gray value of the pixel block in the fingerprint part, which is not lower than the optimal threshold corresponding to the fingerprint image is extracted as the second gray value data;
S24: Using the first gray value data to set the first candidate scale threshold for the fingerprint part;
S25: Using the second gray value data to set the second candidate gray threshold for the fingerprint part;
S26: The first candidate gray threshold is compared with the second candidate gray threshold, and select the larger of the first and second candidate gray thresholds as the first grayscale threshold, and select the smaller of the first and second candidate gray thresholds as the second gray threshold.

Wherein, the first candidate gray threshold and the second candidate gray threshold are obtained by the following formula:

$${H}_{01} = ( 1 + {α}_{1} \cdot ( {X}_{max} - \sqrt{\frac{1}{{n}_{1}} \cdot {\sum }_{i = 1}^{{n}_{1}} {( {H}_{i} - \frac{1}{{n}_{1}} \cdot {\sum }_{i = 1}^{{n}_{1}} {H}_{i} )}^{2}} ) ) \cdot {H}_{z}$$

$${α}_{1} = \frac{1}{{n}_{1} \cdot L} \cdot {\sum }_{i = 1}^{{n}_{1}} \frac{{H}_{z} - {H}_{i}}{{H}_{z}} \cdot ( 1 - {P}_{i} )$$

Among them, H₀₁ represents the first candidate gray threshold; H_{z} indicates the optimal threshold; Xₘₐₓ represents the value of the inter-class variance corresponding to the optimal threshold. n₁ indicates the number of pixel blocks corresponding to the first gray value data; Hᵢ represents the gray value corresponding to the i-th pixel block; α₁ represents the first threshold adjustment coefficient; L represents the total level of gray level contained in the fingerprint image; Pᵢ represents the probability of occurrence of the gray level corresponding to the i-th pixel block in the first gray value data;

$${H}_{02} = ( 1 - {α}_{2} \cdot ( \sqrt{\frac{1}{{n}_{2}} \cdot {\sum }_{j = 1}^{{n}_{2}} {( {H}_{j} - \frac{1}{{n}_{2}} \cdot {\sum }_{j = 1}^{{n}_{2}} {H}_{j} )}^{2}} - {X}_{max} ) ) \cdot {H}_{z}$$

$${α}_{2} = \frac{1}{{n}_{2} \cdot L} \cdot {\sum }_{j = 1}^{{n}_{2}} \frac{{H}_{z} - {H}_{j}}{{H}_{z}} \cdot {P}_{j}$$

Among them, H₀₂ represents the second candidate gray threshold; H_{z} indicates the optimal threshold; Xₘₐₓ represents the value of the inter-class variance corresponding to the optimal threshold. n₂ indicates the number of pixel blocks corresponding to the second gray value data; Hⱼ represents the gray value corresponding to the j-th pixel block; α₂ represents the second threshold adjustment coefficient; L represents the total level of gray level contained in the fingerprint image; Pⱼ represents the probability of occurrence of the gray level corresponding to the j-th pixel block in the second gray value data.

The working principle of the above technical scheme is as follows: extracting the gray value of the pixel block of the fingerprint part of the current fingerprint image; The gray value of the pixel block in the fingerprint part that is lower than the optimal threshold value corresponding to the fingerprint image (the optimal threshold value can be obtained by otsu algorithm) is extracted as the first gray value data; The gray value of the pixel block in the fingerprint part which is not lower than the optimal threshold corresponding to the fingerprint image is extracted as the second gray value data; The first candidate gray threshold of the fingerprint part is set by using the first gray value data; The second candidate gray threshold of the fingerprint part is set by using the second gray value data; The first candidate gray threshold is compared with the second candidate gray threshold, and the larger candidate gray threshold between the first candidate gray threshold and the second candidate gray threshold is taken as the first gray threshold, and the smaller candidate gray threshold between the first candidate gray threshold and the second candidate gray threshold is taken as the second gray threshold.

The effect of the above technical scheme is as follows: by extracting the gray value of the pixel block in the fingerprint image, and determining the first and second gray value data according to the best threshold, the scheme can automatically adjust the gray threshold according to the characteristics of different fingerprint images, so as to adapt to different fingerprint images; By comparing the first and second candidate gray threshold values, the relatively suitable threshold values are selected as the first and second gray threshold values, which can ensure the high-precision processing of the current fingerprint image and improve the accuracy of fingerprint recognition. By processing the gray value based on pixel block, the scheme considers more information in the process of extracting gray value and determining gray threshold, thus improving the reliability and robustness of fingerprint image. Due to the calculation process of the scheme is relatively simple and does not require a lot of computing resources, the first and second gray thresholds can be quickly obtained and determined, which is suitable for real-time fingerprint image processing. The above calculation formulas for the first candidate gray threshold and the second candidate gray threshold mentioned above improve the rationality of threshold setting, thus improving the accuracy of subsequent calibration of each target area and the characterization of fingerprint characteristics in the target area. By improving the accuracy of subsequent calibration of each target area and the characterization of fingerprint characteristics of the fingerprint part in the target area, the recognition accuracy of only local fingerprints can be effectively improved. At the same time, the optimal threshold and inter-class variance values are used as references in the formula. By adjusting the threshold adjustment coefficients α₁ and α₂, the first and second candidate gray thresholds can be adaptively determined according to the gray distribution of pixel blocks in the first and second gray value data. This can better adapt to the characteristics of different fingerprint images, improve the accuracy and robustness of fingerprint recognition; In the formula, the probability Pᵢ and Pⱼ of the gray level where the gray value of the pixel block is located in the first and second gray value data are considered. This can better reflect the distribution of different gray levels in the fingerprint image, making the selection of candidate gray threshold more reasonable and accurate. The adjustment coefficients α₁ and α₂ are introduced into the formula to control the adjustment amplitude of the candidate gray threshold. By setting the adjustment coefficient reasonably, the accuracy and sensitivity of the gray threshold can be further adjusted on the basis of maintaining the adaptability, so as to improve the performance of the fingerprint recognition system.

### Example 3

In this embodiment, the first gray threshold and the second gray threshold to obtain a plurality of image blocks to be recognized, and combining the gray value of the image block to be recognized to obtain the comprehensive similarity value of the current fingerprint image, including:
S31: The fingerprint image is segmented by the first gray threshold and the second gray threshold, and multiple first image blocks and second image blocks to be recognized are obtained;
S32: Compare the multiple first and second image blocks to be recognized with the corresponding fingerprint positions of the fingerprint reference images that the user has entered into the database, and obtain the similarity values for each of the multiple first and second image blocks to be recognized;
S33: Using the similarity values corresponding to each of the multiple first and second image blocks to be recognized, combined with the gray value of the image to be recognized, to obtain the comprehensive similarity value of the current fingerprint image.

Wherein, the comprehensive similarity value of the current fingerprint image can be obtained by the following formula:

$$SIM = 0.5 \cdot ( {λ}_{1} \cdot {S}_{p 1} + {λ}_{2} \cdot {S}_{p 2} )$$

$${λ}_{1} = ( 1 + \frac{{C}_{1}}{{C}_{z}} \cdot {B}_{s} ) \cdot \frac{1}{{C}_{1}} {\sum }_{i = 1}^{{C}_{1}} ( \frac{{M}_{i} - {N}_{02}}{{N}_{01}} - \frac{{N}_{i} - {N}_{01}}{{N}_{02}} )$$

$${λ}_{2} = ( 1 + \frac{{C}_{2}}{{C}_{z}} \cdot {B}_{s} ) \cdot \frac{1}{{C}_{2}} {\sum }_{j = 1}^{{C}_{2}} ( \frac{{N}_{j} - {N}_{02}}{{N}_{01}} - \frac{{M}_{j} - {N}_{01}}{{N}_{02}} )$$

Among them, SIM represents the comprehensive similarity value; Sₚ₁ represents the average similarity value of all the first image blocks to be recognized; Sₚ₂ represents the average similarity value of all the second image blocks to be recognized. λ₁ and λ₂ represent the weight coefficients corresponding to the first image block and the second image block to be recognized, respectively. C₁ and C₂ represent the number of the first and second image blocks to be recognized, respectively. Bₛ represents the ratio between the area of the first target region and the area of the second target region; Nᵢ represents the number of the first type of pixel blocks contained in the i-th first image block to be recognized; Mᵢ represents the number of pixel blocks whose gray value is greater than the second gray threshold in the first type of pixel block contained in the i-th first image block to be recognized; N₀₁ indicates the first block threshold; N₀₂ indicates the second block number threshold. Nⱼ represents the number of the second type of pixel blocks contained in the j-th second image block to be recognized; Mⱼ represents the number of pixel blocks whose gray value of the second type of pixel block contained in the j-th second image block to be recognized is not lower than the first gray threshold.

The working principle of the above technical scheme is as follows: the fingerprint image is segmented by the first gray threshold and the second gray threshold, and obtain multiple first image blocks and second image blocks to be recognized. These image blocks contain different feature regions in fingerprint images; Next, each of the first and second image blocks to be recognized is compared with the fingerprint reference image that the user has entered into the database. Similar comparison can use a variety of fingerprint matching algorithms, such as comparison algorithms based on feature points, lines, etc. By comparison, the similarity value between each image block and fingerprint reference image in database can be calculated. The similarity value of the first and second image blocks and the gray value of the corresponding image blocks are combined to calculate the comprehensive similarity value of the current fingerprint image.

The effect of the above technical scheme is that by segmenting the fingerprint image into multiple image blocks and comparing them with the fingerprint reference images in the database, the accuracy of the fingerprint recognition system can be improved. Because each image block can match the fingerprint image in the database more precisely, the overall matching error is reduced. After the fingerprint image is segmented, each image block can be compared independently, so that even if there are some damaged, polluted or deformed areas in the entire fingerprint image, the impact of these problems on the overall matching result can be avoided. This enhances the robustness of the system to various fingerprint changes; Compared to directly matching the entire fingerprint image, after segmenting it into multiple image blocks, the similarity comparison of each image block can be processed in parallel, thereby improving the matching speed. Because the size of each image block is small, the required computational load is correspondingly reduced, which can make more effective use of computing resources, optimize the performance of the algorithm and improve the recognition rate. Combined with the gray value of the image block to be recognized, the similarity of the fingerprint image can be evaluated more comprehensively. The gray value reflects the brightness information inside the image block. By considering the similarity value and gray value comprehensively, the matching degree of the fingerprint can be more accurately judged. The above formula can improve the accuracy of similarity evaluation by synthesizing similarity, and the setting of weight can effectively improve the accuracy of determining the representational importance of pixel blocks within the range of corresponding gray values, and further improve the accuracy of obtaining the comprehensive similarity threshold. At the same time, by introducing weight coefficients λ₁ and λ₂, different weights can be assigned to different image blocks to be recognized. In this way, the influence of different image blocks on the overall similarity can be adjusted according to the actual situation, and the flexibility of similarity calculation can be improved. The Bₛ in the formula represents the ratio between the area of the first target region and the area of the second target region. This ratio can be used to measure the difference in the size of the fingerprint area occupied by two image blocks to be recognized. By considering the area ratio of target region, the similarity of image blocks of different sizes can be evaluated reasonably. Nᵢ and Mⱼ in the formula represent the number of pixel blocks in the i-th first image block and the j-th second image block and the number of pixel blocks that reach a certain gray threshold, respectively. In this way, the statistical information of the gray value of pixel blocks can be introduced into the similarity calculation, and the internal brightness characteristics of image blocks can be considered more comprehensively. N₀₁ and N₀₂ in the formula are related to the first gray threshold and the second gray threshold. These thresholds can be adjusted according to the actual situation to meet the characteristics and needs of different fingerprint images. The adaptability and accuracy of similarity calculation can be improved by adaptive threshold setting.

### Example 4

In this embodiment, the fingerprint image is segmented through the first gray threshold and the second gray threshold to obtain a plurality of image blocks to be recognized, including:
S311: Extract gray values of all pixel blocks in the fingerprint part of the fingerprint image;
S312: Extract pixel blocks with gray values exceeding the first gray threshold as the first type of pixel block;
S313: In the first type of pixel block, the target area containing the number of block of the first type of pixel block exceeding the preset threshold value of the first block number in the first target area is called as the first target area;
S314: According to the position of the first target area, the fingerprint image is segmented to obtain the first image block to be recognized;
S315: The pixel block whose gray value exceeds the second gray threshold, but does not exceed the first gray threshold, is extracted as the second type of pixel block;
S316: In the second type of pixel block, the target area containing the number of block of the second type of pixel block exceeding the preset threshold value of the second block number in the target area is called as the second target area;
S317: According to the position of the second target area, the fingerprint image is segmented to obtain the second image block to be recognized.

The working principle of the above technical scheme is as follows: extract all pixel blocks from the entire fingerprint image and record their gray values; The pixel blocks whose gray value exceeds the first gray threshold are recognized, which may represent the main feature parts of fingerprint images. In the first type of pixel blocks, the target area that meets the preset threshold of the number of the first block is found, that is, the area that contains enough of the first type of pixel blocks in a certain range. This area is considered the first target area; According to the location information of the first target region, the fingerprint image is segmented and the first image block to be recognized is extracted, which may contain important features of the fingerprint. Then, the pixel blocks whose gray value is between the first gray threshold and the second gray threshold but not up to the second gray threshold are recognized. These pixel blocks may contain secondary fingerprint features. In the second type of pixel block, the target area that meets the preset threshold of the number of the second type of pixel block is found, which also contains enough of the second type of pixel block as the second target area. According to the location information of the second target area, the fingerprint image is segmented to extract the second image block to be recognized, which may contain secondary fingerprint features.

The effect of the above technical scheme is that by segmenting and extracting areas from fingerprint images, it is possible to accurately extract image blocks to be recognized that contain both primary and secondary fingerprint features, which is helpful to improve the accuracy and comprehensiveness of fingerprint recognition systems for fingerprint features; By setting the first gray threshold and the second gray threshold, the noise and non-fingerprint areas in the image can be effectively filtered out, thus increasing the attention to the fingerprint part and reducing the impact of noise on the recognition result. Segmenting the fingerprint image into multiple image blocks to be recognized, and the feature information of different regions is processed respectively, which is helpful to increase the recognition robustness of different fingerprint features and improve the fingerprint recognition effect of the system in complex environment. Through multiple segmentation and extraction, the technical scheme can capture the feature information in the fingerprint image more comprehensively, thus improving the accuracy and reliability of the fingerprint recognition system, and making it more suitable for various practical application scenarios. By extracting pixel blocks that exceed the first gray threshold and those that do not exceed the first gray threshold but exceed the second gray threshold, the fingerprint features can be extracted more accurately and the recognition accuracy can be improved. In the first type of pixel block and the second type of pixel block, the fingerprint image can be segmented according to the location of the target area, and the image block to be recognized can be obtained, thus avoiding the overall processing of the recognized image block, reducing the computational complexity and improving the computational efficiency. When processing a large number of fingerprint images, this segmentation and recognition method based on the target region can significantly reduce the amount of data that needs to be stored and processed, thus optimizing the use of storage space. Because the pixel block classification method based on gray threshold and the target selection method based on the target area can effectively avoid illegal intrusion and security loopholes, and improve the security of the access control system.

### Example 5

In this embodiment, the first target area is smaller than the second target area, and the ratio between the first target area and the second target area is 1:1.7-1:2.3; At the same time, the first block count threshold is smaller than the second block count threshold, and the ratio between the first block count threshold and the second block count threshold is 1:2.1-1:2.8.

The working principle of the above technical scheme is as follows: Firstly, the area of the first target area and the second target area are calculated for a specific area in the fingerprint image, and the proportion between the area of the first target area and the area of the second target area is 1:1.7-1:2.3. This means that after the calculated area of the target area, the system will be compared and screened, and only the target area that meets the specific proportion range will be retained; The ratio between the first block count threshold and the second block count threshold is 1:2.1-1:2.8.

The effect of the above technical scheme is that by limiting and filtering the target area and numerical threshold, the accuracy and precision of fingerprint image processing can be improved. Only target areas and values that fit a specific proportional ranges are retained, thus reducing the possibility of misjudgment and misidentification; Setting specific proportional ranges and numerical thresholds can enhance the system's resistance to noise and interference. This means that even if there is a certain degree of interference, the system can still identify and extract fingerprint features. By flexibly setting the proportional ranges and numerical thresholds, the technology scheme may have a certain degree of adaptability, and can be applied to different types and qualities of fingerprint images, and overcome the challenges brought by image quality and environmental changes to a certain extent. Once the appropriate proportional range and numerical threshold are determined, the technical scheme may be able to process large amounts of fingerprint image data quickly and efficiently, thus improving the processing efficiency and response speed.

### Example 6

The embodiment relates to a fingerprint identification access control system. The fingerprint identification access control system includes:
Image acquisition module: real-time acquisition of fingerprint images for the same user for fingerprint recognition;
Threshold acquisition module: According to the gray value of the pixel block of the fingerprint part of the currently collected fingerprint image, the first gray threshold and the second gray threshold corresponding to the current fingerprint image are obtained. Wherein, the first gray threshold is greater than the second gray threshold;
Image block acquisition module: using the first gray threshold value and the second gray threshold value to obtain a plurality of image blocks to be recognized, and combined with the gray value of the image blocks to be recognized to obtain the comprehensive similarity value of the current fingerprint image;
Similarity judgment module: When the comprehensive similarity value is not lower than the preset similarity threshold, the fingerprint image of the current user is judged to pass fingerprint verification.

The working principle of the above technical scheme is as follows: the user presses the fingerprint sensor on the access control system, and the system collects the fingerprint image of the user for fingerprint recognition in real time. By analyzing the gray value of the pixel block in the fingerprint part of the currently collected fingerprint image, the system obtains the first gray threshold and the second gray threshold corresponding to the current fingerprint image. These thresholds may be used to identify specific features in fingerprint images for subsequent comparison and verification. Using the first gray threshold value and the second gray threshold value, the system divides the fingerprint image into multiple image blocks to be recognized, and combines the gray value of these image blocks to calculate the comprehensive similarity value of the current fingerprint image. This step may involve extracting the features of the fingerprint image and then comparing them with the reference features stored in the database to calculate the similarity. When the comprehensive similarity value reaches or exceeds the preset similarity threshold, the system determines that the fingerprint image of the current user passes fingerprint verification, thus allowing the user to obtain the access control permission.

The effects of the above technical scheme are as follows: the technical scheme can improve the user experience, provide a novel gray value comparison method, avoid the complex manual feature extraction and matching process, greatly save time and computing resources, save a lot of manpower and material resources, improve operation and maintenance efficiency and management level. By analyzing the gray value of fingerprint image and calculating the comprehensive similarity, the fingerprint image can be recognized with high precision. This helps ensure that only authorized users can pass through the access control system, increasing security. Through the use of gray threshold, it is possible to effectively deal with some simple fingerprint forgery attacks, such as using false fingerprints. This increases the security of the access control system and avoids being deceived by illegally copied fingerprints. The process of collecting and processing fingerprint images is real-time, so the user can quickly obtain the corresponding verification results after pressing the fingerprint on the access control system, improving the user experience. The method dynamically obtains the gray threshold based on the features of the currently collected fingerprint images, and calculates the similarity based on the gray values of the image blocks to be recognized. Therefore, the method can adapt to the changes of fingerprint features in different environments, and improves the robustness and applicability of the system. Judging by the preset similarity threshold can avoid misjudgment and missing judgment to a certain extent, and improve the reliability of fingerprint verification.

### Example 7

In this embodiment, the threshold acquisition module, including:
Gray value extraction module: extract the gray value of the pixel block of the fingerprint part of the current fingerprint image;
The first gray value data module: extracts the gray value of the pixel block in the fingerprint part that is lower than the optimal threshold corresponding to the fingerprint image, and takes it as the first gray value data;
The second gray value data module: extracts the gray value of the pixel block in the fingerprint part which is not lower than the optimal threshold corresponding to the fingerprint image, and takes it as the second gray value data;
The first candidate gray threshold module: using the first gray value data to set the first candidate gray threshold of the fingerprint part;
The second candidate gray threshold module: using the second gray value data to set the second candidate gray threshold of the fingerprint part;
Threshold comparison module: the first candidate gray threshold is compared with the second candidate gray threshold, and the larger candidate gray threshold between the first candidate gray threshold and the second candidate gray threshold is taken as the first gray threshold, and the smaller candidate gray threshold between the first candidate gray threshold and the second candidate gray threshold is taken as the second gray threshold.

Wherein, the first candidate gray threshold and the second candidate gray threshold are obtained by the following formula:

$${H}_{01} = ( 1 + {α}_{1} \cdot ( {X}_{max} - \sqrt{\frac{1}{{n}_{1}} \cdot {\sum }_{i = 1}^{{n}_{1}} {( {H}_{i} - \frac{1}{{n}_{1}} \cdot {\sum }_{i = 1}^{{n}_{1}} {H}_{i} )}^{2}} ) ) \cdot {H}_{z}$$

$${α}_{1} = \frac{1}{{n}_{1} \cdot L} {\sum }_{i = 1}^{{n}_{1}} \frac{{H}_{z} - {H}_{i}}{{H}_{z}} \cdot ( 1 - {P}_{i} )$$

Among them, H₀₁ represents the first candidate gray threshold; H_{z} indicates the optimal threshold; Xₘₐₓ represents the value of the inter-class variance corresponding to the optimal threshold. n₁ indicates the number of pixel blocks corresponding to the first gray value data; Hᵢ represents the gray value corresponding to the i-th pixel block; α₁ represents the first threshold adjustment coefficient; L represents the total level of gray level contained in the fingerprint image; Pᵢ represents the probability of occurrence of the gray level corresponding to the i-th pixel block in the first gray value data;

$${H}_{02} = ( 1 - {α}_{2} \cdot ( \sqrt{\frac{1}{{n}_{2}} \cdot {\sum }_{j = 1}^{{n}_{2}} {( {H}_{j} - \frac{1}{{n}_{2}} \cdot {\sum }_{j = 1}^{{n}_{2}} {H}_{j} )}^{2}} - {X}_{max} ) ) \cdot {H}_{z}$$

$${α}_{2} = \frac{1}{{n}_{2} \cdot L} \cdot {\sum }_{j = 1}^{{n}_{2}} \frac{{H}_{z} - {H}_{j}}{{H}_{z}} \cdot {P}_{j}$$

Among them, H₀₂ represents the second candidate gray threshold; H_{z} indicates the optimal threshold; Xₘₐₓ represents the value of the inter-class variance corresponding to the optimal threshold. n₂ indicates the number of pixel blocks corresponding to the second gray value data; H represents the gray value corresponding to the j-th pixel block; α₂ represents the second threshold adjustment coefficient; L represents the total level of gray level contained in the fingerprint image; Pⱼ represents the probability of occurrence of the gray level corresponding to the j-th pixel block in the second gray value data.

The working principle of the above technical scheme is as follows: extracting the gray value of the pixel block of the fingerprint part of the current fingerprint image; The gray value of the pixel block in the fingerprint part that is lower than the optimal threshold value corresponding to the fingerprint image (the optimal threshold value can be obtained by otsu algorithm) is extracted as the first gray value data; The gray value of the pixel block in the fingerprint part which is not lower than the optimal threshold corresponding to the fingerprint image is extracted as the second gray value data; The first candidate gray threshold of the fingerprint part is set by using the first gray value data; The second candidate gray threshold of the fingerprint part is set by using the second gray value data; The first candidate gray threshold is compared with the second candidate gray threshold, and the larger candidate gray threshold between the first candidate gray threshold and the second candidate gray threshold is taken as the first gray threshold, and the smaller candidate gray threshold between the first candidate gray threshold and the second candidate gray threshold is taken as the second gray threshold.

The effect of the above technical scheme is as follows: by extracting the gray value of the pixel block in the fingerprint image, and determining the first and second gray value data according to the best threshold, the scheme can automatically adjust the gray threshold according to the characteristics of different fingerprint images, so as to adapt to different fingerprint images; By comparing the first and second candidate gray threshold values, the relatively suitable threshold values are selected as the first and second gray threshold values, which can ensure the high-precision processing of the current fingerprint image and improve the accuracy of fingerprint recognition. By processing the gray value based on pixel block, the scheme considers more information in the process of extracting gray value and determining gray threshold, thus improving the reliability and robustness of fingerprint image. Due to the calculation process of the scheme is relatively simple and does not require a lot of computing resources, the first and second gray thresholds can be quickly obtained and determined, which is suitable for real-time fingerprint image processing. The above calculation formulas for the first candidate gray threshold and the second candidate gray threshold mentioned above improve the rationality of threshold setting, thus improving the accuracy of subsequent calibration of each target area and the characterization of fingerprint characteristics in the target area. By improving the accuracy of subsequent calibration of each target area and the characterization of fingerprint characteristics of the fingerprint part in the target area, the recognition accuracy of only local fingerprints can be effectively improved. At the same time, the optimal threshold and inter-class variance values are used as references in the formula. By adjusting the threshold adjustment coefficients α₁ and α₂, the first and second candidate gray thresholds can be adaptively determined according to the gray distribution of pixel blocks in the first and second gray value data. This can better adapt to the characteristics of different fingerprint images, improve the accuracy and robustness of fingerprint recognition; In the formula, the probability Pᵢ and Pⱼ of the gray level where the gray value of the pixel block is located in the first and second gray value data are considered. This can better reflect the distribution of different gray levels in the fingerprint image, making the selection of candidate gray threshold more reasonable and accurate. The adjustment coefficients α₁ and α₂ are introduced into the formula to control the adjustment amplitude of the candidate gray threshold. By setting the adjustment coefficient reasonably, the accuracy and sensitivity of the gray threshold can be further adjusted on the basis of maintaining the adaptability, so as to improve the performance of the fingerprint recognition system.

### Example 8

In this embodiment, the image block acquisition module, including:
To be recognized image block acquisition module: the fingerprint image is segmented by the first gray threshold and the second gray threshold, and multiple first and second image blocks to be recognized are obtained;
Similarity value comparison module: the first and second image blocks to be recognized are compared with the fingerprint position corresponding to the fingerprint reference image that the user has entered into the database, and the corresponding similarity value of the first and second image blocks to be recognized is obtained.

Similarity value acquisition module: using the similarity values corresponding to each of the multiple first and second image blocks to be recognized, combined with the scale value of the image to be recognized, to obtain the comprehensive similarity value of the current fingerprint image.

Wherein, the comprehensive similarity value of the current fingerprint image can be obtained by the following formula:

$$SIM = 0.5 \cdot ( {λ}_{1} \cdot {S}_{p 1} + {λ}_{2} \cdot {S}_{p 2} )$$

$${λ}_{1} = ( 1 + \frac{{C}_{1}}{{C}_{z}} \cdot {B}_{s} ) \cdot \frac{1}{{C}_{1}} {\sum }_{i = 1}^{{C}_{1}} ( \frac{{M}_{i} - {N}_{02}}{{N}_{01}} - \frac{{N}_{i} - {N}_{01}}{{N}_{02}} )$$

$${λ}_{2} = ( 1 + \frac{{C}_{2}}{{C}_{z}} \cdot {B}_{s} ) \cdot \frac{1}{{C}_{2}} {\sum }_{j = 1}^{{C}_{2}} ( \frac{{N}_{j} - {N}_{02}}{{N}_{01}} - \frac{{M}_{j} - {N}_{01}}{{N}_{02}} )$$

Among them, SIM represents the comprehensive similarity value; Sₚ₁ represents the average similarity value of all the first image blocks to be recognized; Sₚ₂ represents the average similarity value of all the second image blocks to be recognized. λ₁ and λ₂ represent the weight coefficients corresponding to the first image block and the second image block to be recognized, respectively. C₁ and C₂ represent the number of the first and second image blocks to be recognized, respectively. Bₛ represents the ratio between the area of the first target region and the area of the second target region; Nᵢ represents the number of the first type of pixel blocks contained in the i-th first image block to be recognized; Mᵢ represents the number of pixel blocks whose gray value is greater than the second gray threshold in the first type of pixel block contained in the i-th first image block to be recognized; N₀₁ indicates the first block threshold; N₀₂ indicates the second block number threshold. Nⱼ represents the number of the second type of pixel blocks contained in the j-th second image block to be recognized; Mⱼ represents the number of pixel blocks whose gray value of the second type of pixel block contained in the j-th second image block to be recognized is not lower than the first gray threshold.

The working principle of the above technical scheme is as follows: the fingerprint image is segmented by the first gray threshold and the second gray threshold, and obtain multiple first image blocks and second image blocks to be recognized. These image blocks contain different feature regions in fingerprint images; Next, each of the first and second image blocks to be recognized is compared with the fingerprint reference image that the user has entered into the database. Similar comparison can use a variety of fingerprint matching algorithms, such as comparison algorithms based on feature points, lines, etc. By comparison, the similarity value between each image block and fingerprint reference image in database can be calculated. The similarity value of the first and second image blocks and the gray value of the corresponding image blocks are combined to calculate the comprehensive similarity value of the current fingerprint image.

The effect of the above technical scheme is that by segmenting the fingerprint image into multiple image blocks and comparing them with the fingerprint reference images in the database, the accuracy of the fingerprint recognition system can be improved. Because each image block can match the fingerprint image in the database more precisely, the overall matching error is reduced. After the fingerprint image is segmented, each image block can be compared independently, so that even if there are some damaged, polluted or deformed areas in the entire fingerprint image, the impact of these problems on the overall matching result can be avoided. This enhances the robustness of the system to various fingerprint changes; Compared to directly matching the entire fingerprint image, after segmenting it into multiple image blocks, the similarity comparison of each image block can be processed in parallel, thereby improving the matching speed. Because the size of each image block is small, the required computational load is correspondingly reduced, which can make more effective use of computing resources, optimize the performance of the algorithm and improve the recognition rate. Combined with the gray value of the image block to be recognized, the similarity of the fingerprint image can be evaluated more comprehensively. The gray value reflects the brightness information inside the image block. By considering the similarity value and gray value comprehensively, the matching degree of the fingerprint can be more accurately judged. The above formula can improve the accuracy of similarity evaluation by synthesizing similarity, and the setting of weight can effectively improve the accuracy of determining the representational importance of pixel blocks within the range of corresponding gray values, and further improve the accuracy of obtaining the comprehensive similarity threshold. At the same time, by introducing weight coefficients λ₁ and λ₂, different weights can be assigned to different image blocks to be recognized. In this way, the influence of different image blocks on the overall similarity can be adjusted according to the actual situation, and the flexibility of similarity calculation can be improved. The Bₛ in the formula represents the ratio between the area of the first target region and the area of the second target region. This ratio can be used to measure the difference in the size of the fingerprint area occupied by two image blocks to be recognized. By considering the area ratio of target region, the similarity of image blocks of different sizes can be evaluated reasonably. Nᵢ and Mⱼ in the formula represent the number of pixel blocks in the i-th first image block and the j-th second image block and the number of pixel blocks that reach a certain gray threshold, respectively. In this way, the statistical information of the gray value of pixel blocks can be introduced into the similarity calculation, and the internal brightness characteristics of image blocks can be considered more comprehensively. N₀₁ and N₀₂ in the formula are related to the first gray threshold and the second gray threshold. These thresholds can be adjusted according to the actual situation to meet the characteristics and needs of different fingerprint images. The adaptability and accuracy of similarity calculation can be improved by adaptive threshold setting.

### Example 9

In this embodiment, the acquisition module of the image block to be recognized, including:
Gray value extraction module: extracting gray value of all pixel blocks in the fingerprint part of the fingerprint image;
The first type of pixel block module: extracts the pixel block whose gray value exceeds the first gray threshold as the first type of pixel block;
Target area setting module: in the first type of pixel block, the target area containing the number of blocks of the first type of pixel block in the area of the first type of pixel block exceeds the preset threshold value of the first block number, as the first target area;
The first image block module to be recognized: according to the position of the first target area, the fingerprint image is segmented to obtain the first image block to be recognized;
The second type of pixel block determination module: extracts the pixel block whose gray value exceeds the second gray threshold, but does not exceed the first gray threshold, as the second type of pixel block;
The area region retrieval module: in the second type of pixel block, retrieve the target area containing the second type of pixel block whose number of blocks exceeds the preset threshold value of the second block number as the second target area;
The second target area module: according to the position of the second target area, the fingerprint image is segmented to obtain the second image block to be recognized.

The working principle of the above technical scheme is as follows: extract all pixel blocks from the entire fingerprint image and record their gray values; The pixel blocks whose gray value exceeds the first gray threshold are recognized, which may represent the main feature parts of fingerprint images. In the first type of pixel blocks, the target area that meets the preset threshold of the number of the first block is found, that is, the area that contains enough of the first type of pixel blocks in a certain range. This area is considered the first target area; According to the location information of the first target region, the fingerprint image is segmented and the first image block to be recognized is extracted, which may contain important features of the fingerprint. Then, the pixel blocks whose gray value is between the first gray threshold and the second gray threshold but not up to the second gray threshold are recognized. These pixel blocks may contain secondary fingerprint features. In the second type of pixel block, the target area that meets the preset threshold of the number of the second type of pixel block is found, which also contains enough of the second type of pixel block as the second target area. According to the location information of the second target area, the fingerprint image is segmented to extract the second image block to be recognized, which may contain secondary fingerprint features.

The effect of the above technical scheme is that by segmenting and extracting areas from fingerprint images, it is possible to accurately extract image blocks to be recognized that contain both primary and secondary fingerprint features, which is helpful to improve the accuracy and comprehensiveness of fingerprint recognition systems for fingerprint features; By setting the first gray threshold and the second gray threshold, the noise and non-fingerprint areas in the image can be effectively filtered out, thus increasing the attention to the fingerprint part and reducing the impact of noise on the recognition result. Segmenting the fingerprint image into multiple image blocks to be recognized, and the feature information of different regions is processed respectively, which is helpful to increase the recognition robustness of different fingerprint features and improve the fingerprint recognition effect of the system in complex environment. Through multiple segmentation and extraction, the technical scheme can capture the feature information in the fingerprint image more comprehensively, thus improving the accuracy and reliability of the fingerprint recognition system, and making it more suitable for various practical application scenarios. By extracting pixel blocks that exceed the first gray threshold and those that do not exceed the first gray threshold but exceed the second gray threshold, the fingerprint features can be extracted more accurately and the recognition accuracy can be improved. In the first type of pixel block and the second type of pixel block, the fingerprint image can be segmented according to the location of the target area, and the image block to be recognized can be obtained, thus avoiding the overall processing of the recognized image block, reducing the computational complexity and improving the computational efficiency. When processing a large number of fingerprint images, this segmentation and recognition method based on the target region can significantly reduce the amount of data that needs to be stored and processed, thus optimizing the use of storage space. Because the pixel block classification method based on gray threshold and the target selection method based on the target area can effectively avoid illegal intrusion and security loopholes, and improve the security of the access control system.

### Example 10

In this embodiment, the first target area is smaller than the second target area, and the ratio between the first target area and the second target area is 1:1.7-1:2.3; At the same time, the first block count threshold is smaller than the second block count threshold, and the ratio between the first block count threshold and the second count block threshold is 1:2.1-1:2.8.

The working principle of the above technical scheme is as follows: Firstly, the area of the first target area and the second target area are calculated for a specific area in the fingerprint image, and the proportion between the area of the first target area and the area of the second target area is 1:1.7-1:2.3. This means that after the calculated area of the target area, the system will be compared and screened, and only the target area that meets the specific proportion range will be retained; The ratio between the first block count threshold and the second block count threshold is 1:2.1-1:2.8.

The effect of the above technical scheme is that by limiting and filtering the target area and numerical threshold, the accuracy and precision of fingerprint image processing can be improved. Only target areas and values that fit a specific proportional ranges are retained, thus reducing the possibility of misjudgment and misidentification; Setting specific proportional ranges and numerical thresholds can enhance the system's resistance to noise and interference. This means that even if there is a certain degree of interference, the system can still identify and extract fingerprint features. By flexibly setting the proportional ranges and numerical thresholds, the technology scheme may have a certain degree of adaptability, and can be applied to different types and qualities of fingerprint images, and overcome the challenges brought by image quality and environmental changes to a certain extent. Once the appropriate proportional range and numerical threshold are determined, the technical scheme may be able to process large amounts of fingerprint image data quickly and efficiently, thus improving the processing efficiency and response speed.

Obviously, technicians in this field can make various alterations and variants of the invention without deviating from the spirit and scope of the invention. Thus, to the extent that these modifications and variations of the invention are within the scope of the claims of the invention and their equivalent technologies, the invention is also intended to include these modifications and variations.

1.-10. (canceled)

11. A fingerprint recognition access control method is characterized in that the fingerprint recognition access control method includes:
Real-time collection of fingerprint images for fingerprint recognition of the same use;
According to the gray value of the pixel block in the fingerprint part of the collected fingerprint image, the first gray threshold and the second gray threshold corresponding to the current fingerprint image are obtained. Wherein, the first gray threshold is greater than the second gray threshold;
Using the first gray threshold and the second gray threshold to obtain a plurality of image blocks to be recognized, and combined with the gray value of the image blocks to obtain the comprehensive similarity value of the current fingerprint image;
When the comprehensive similarity value is not lower than the preset similarity threshold, the fingerprint image of the current user is judged to pass fingerprint verification;
According to the gray values of the pixel block of the fingerprint part of the currently collected fingerprint image, the first gray threshold and the second gray threshold corresponding to the current fingerprint image are obtained, including:
Extract the gray value of the pixel block of the fingerprint part of the current fingerprint image;
The gray value of the pixel block in the fingerprint part, which is lower than the optimal threshold corresponding to the fingerprint image is extracted as the first gray value data;
The gray value of the pixel block in the fingerprint part, which is not lower than the optimal threshold corresponding to the fingerprint image is extracted as the second gray value data;
Using the first gray value data to set the first candidate scale threshold for the fingerprint part;
Using the second gray value data to set the second candidate gray threshold for the fingerprint part;
The first candidate gray threshold is compared with the second candidate gray threshold, and select the larger of the first and second candidate gray thresholds as the first grayscale threshold, and select the smaller of the first and second candidate gray thresholds as the second gray threshold.

12. According to the fingerprint recognition access control method mentioned in claim 11, it is characterized that using the first gray threshold and the second gray threshold to obtain a plurality of image blocks to be recognized, and combining the gray value of the image block to be recognized to obtain the comprehensive similarity value of the current fingerprint image, including:
The fingerprint image is segmented by the first gray threshold and the second gray threshold, and multiple first image blocks and second image blocks to be recognized are obtained;
Compare the multiple first and second image blocks to be recognized with the corresponding fingerprint positions of the fingerprint reference images that the user has entered into the database, and obtain the similarity values for each of the multiple first and second image blocks to be recognized;
Using the similarity values corresponding to each of the multiple first and second image blocks to be recognized, combined with the gray value of the image to be recognized, to obtain the comprehensive similarity value of the current fingerprint image.

13. According to the fingerprint recognition access control method mentioned in claim 12, it is characterized that the fingerprint image is segmented through the first gray threshold and the second gray threshold to obtain a plurality of image blocks to be recognized, including:
Extract gray values of all pixel blocks in the fingerprint part of the fingerprint image;
Extract pixel blocks with gray values exceeding the first gray threshold as the first type of pixel block;
In the first type of pixel block, the target area containing the number of block of the first type of pixel block exceeding the preset threshold value of the first block number in the first target area is called as the first target area;
According to the position of the first target area, the fingerprint image is segmented to obtain the first image block to be recognized;
The pixel block whose gray value exceeds the second gray threshold, but does not exceed the first gray threshold, is extracted as the second type of pixel block;
In the second type of pixel block, the target area containing the number of block of the second type of pixel block exceeding the preset threshold value of the second block number in the target area is called as the second target area;
According to the position of the second target area, the fingerprint image is segmented to obtain the second image block to be recognized.

14. According to the fingerprint recognition access control method mentioned in claim 13, it is characterized that the first target area is smaller than the second target area, and the ratio between the first target area and the second target area is 1:1.7-1:2.3; At the same time, the first block count threshold is smaller than the second block count threshold, and the ratio between the first block count threshold and the second block count threshold is 1:2.1-1:2.8.

15. A fingerprint recognition access control system is characterized in that the fingerprint recognition access control system includes:
Image acquisition module: real-time acquisition of fingerprint images for the same user for fingerprint recognition;
Threshold acquisition module: According to the gray value of the pixel block of the fingerprint part of the currently collected fingerprint image, the first gray threshold and the second gray threshold corresponding to the current fingerprint image are obtained. Wherein, the first gray threshold is greater than the second gray threshold;
Image block acquisition module: using the first gray threshold value and the second gray threshold value to obtain a plurality of image blocks to be recognized, and combined with the gray value of the image blocks to be recognized to obtain the comprehensive similarity value of the current fingerprint image;
Similarity judgment module: When the comprehensive similarity value is not lower than the preset similarity threshold, the fingerprint image of the current user is judged to pass fingerprint verification; the threshold acquisition module comprises:
Gray value extraction module: extract the gray value of the pixel block of the fingerprint part of the current fingerprint image;
The first gray value data module: extracts the gray value of the pixel block in the fingerprint part that is lower than the optimal threshold corresponding to the fingerprint image, and takes it as the first gray value data;
The second gray value data module: extracts the gray value of the pixel block in the fingerprint part which is not lower than the optimal threshold corresponding to the fingerprint image, and takes it as the second gray value data;
The first candidate gray threshold module: using the first gray value data to set the first candidate gray threshold of the fingerprint part;
The second candidate gray threshold module: using the second gray value data to set the second candidate gray threshold of the fingerprint part;
Threshold comparison module: the first candidate gray threshold is compared with the second candidate gray threshold, and the larger candidate gray threshold between the first candidate gray threshold and the second candidate gray threshold is taken as the first gray threshold, and the smaller candidate gray threshold between the first candidate gray threshold and the second candidate gray threshold is taken as the second gray threshold.

16. According to the fingerprint recognition access control system mentioned in claim 15, it is characterized that the image block acquisition module, including:
To be recognized image block acquisition module: the fingerprint image is segmented by the first gray threshold and the second gray threshold, and multiple first and second image blocks to be recognized are obtained;
Similarity value comparison module: the first and second image blocks to be recognized are compared with the fingerprint position corresponding to the fingerprint reference image that the user has entered into the database, and the corresponding similarity value of the first and second image blocks to be recognized is obtained.
Similarity value acquisition module: using the similarity values corresponding to each of the multiple first and second image blocks to be recognized, combined with the scale value of the image to be recognized, to obtain the comprehensive similarity value of the current fingerprint image.

17. According to the fingerprint recognition access control system mentioned in claim 16, it is characterized that the acquisition module of the image block to be recognized, including:
Gray value extraction module: extracting gray value of all pixel blocks in the fingerprint part of the fingerprint image;
The first type of pixel block module: extracts the pixel block whose gray value exceeds the first gray threshold as the first type of pixel block;
Target area setting module: in the first type of pixel block, the target area containing the number of blocks of the first type of pixel block in the area of the first type of pixel block exceeds the preset threshold value of the first block number, as the first target area;
The first image block module to be recognized: according to the position of the first target area, the fingerprint image is segmented to obtain the first image block to be recognized;
The second type of pixel block determination module: extracts the pixel block whose gray value exceeds the second gray threshold, but does not exceed the first gray threshold, as the second type of pixel block;
The area region retrieval module: in the second type of pixel block, retrieve the target area containing the second type of pixel block whose number of blocks exceeds the preset threshold value of the second block number as the second target area;
The second target area module: according to the position of the second target area, the fingerprint image is segmented to obtain the second image block to be recognized.

18. According to the fingerprint recognition access control system mentioned in claim 17, it is characterized that the first target area is smaller than the second target area, and the ratio between the first target area and the second target area is 1:1.7-1:2.3; At the same time, the first block count threshold is smaller than the second block count threshold, and the ratio between the first block count threshold and the second count block threshold is 1:2.1-1:2.8.
